(19) United States
(12) Patent Application Publication
(10) Pub. No.: US 2003/0184443 A1
(43) Pub. Date: Oct. 2, 2003

(54) Static-alert

(75) Inventor: Leland J. Roys, Cupertino, CA (US)

Correspondence Address: LELAND J. ROYS, 10045 CRESCENT RD., CUPERTINO, CA, 95014, US

(73) Assignee: Mr. Leland John Roys, Cupertino, CA (US)

(21) Appl. No.: 10/063,222

(22) Filed: Mar. 29, 2002

(51) Int. Cl. G08B 21/00

(52) U.S. Cl. 340/608; 340/945

(57) ABSTRACT

An electronic unit that can detect and warn of aircraft static air system failure. The invention, using electronic pressure and vacuum measuring devices, can detect and warn the pilot of blockage of the aircraft static air system, thus allowing the pilot to take measures to use an alternate static air system, or at least be aware that the condition exits. The invention provides visual and audible warnings when the static air system has failed. The invention could also allow the pilot to take corrective measures to open an alternate static air source by using a manual or electric air valve in the invention.

### BACKGROUND OF INVENTION

All General Aviation aircraft flying today use a “static air system” to allow air pressure to be distributed to instruments within the aircraft cabin. The static air system is needed to provide the outside air pressure (through the use of plastic/aluminum tubing) to the various instruments (such as the altimeter) as to allow their proper operation.

It is possible that the static air system can become blocked (clogged). This can happen due to multiple circumstances. Examples would be blockage of the static ports on the outside of the aircraft by insects, ice accretion (while on the ground or in flight), or water droplets. In addition to these causes, water droplets can also freeze within the static line and block the tubing.

Currently, if the static air system becomes blocked, the results can be dangerous for the pilot and passengers while in flight. If an aircraft is flying in the clouds without reference to the outside environment, and the static air system is disabled, the pilot will lose the ability to reference several necessary flight instruments (Altimeter, Vertical Airspeed Indicator, and Airspeed Indicator). Also, it is very difficult to determine that the static air system has been blocked when already in flight; it might also be possible that the static air system becomes slowly blocked over time, this makes it even harder for the pilot to determine that the static air system blockage has occurred. Having the static air system blocked, while in instrument conditions (in the clouds), could and has resulted in pilot and passenger injury and death.

My invention will allow detection and warning of aircraft static air system blockage.

### SUMMARY OF INVENTION

This invention allows a pilot to be warned of blockages to the static air system of an aircraft. The invention will both audibly and visually warn the pilot of static air system blockage and allow the pilot to take appropriate action to resolve the problem.

### BRIEF DESCRIPTION OF DRAWINGS

FIG. 1 is a block diagram of the invention parts.

### BRIEF DESCRIPTION OF SEQUENCES

Reference Figures

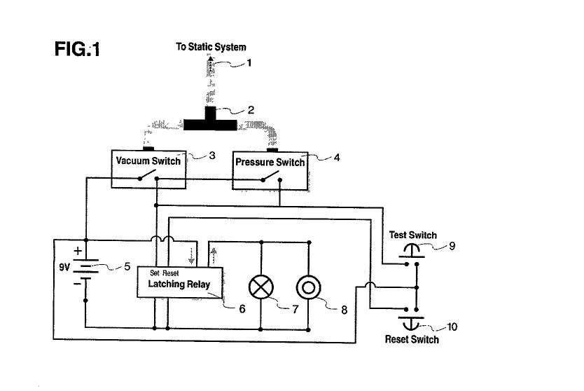

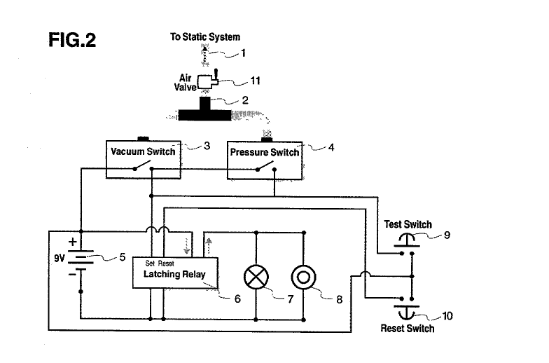

FIG. 1 Invention enclosure

Reference Numerals in FIG. 1

1 Plastic air pressure tubing

2 Tee Connector, used to split tubing into two separate tubes for each pressure/vacuum switch

3 Mechanical Vacuum Switch, when set vacuum level reached the switch contacts will close

4 Mechanical Pressure Switch, when set pressure level reached, the switch contacts will close

5 9 volt battery for power supply

6 Latching Type Relay with inputs from: (Vacuum Switch, Pressure Switch, Set test Switch, Reset Switch)

7 Light Emitting Diode type light (5-13 volts)

8 Piezoelectric Buzzer

9 Momentary Test Switch

10 Momentary Reset Switch

### Detailed Description—FIG. 1—Preferred Embodiment

The static air system blockage detector uses the physics of differential pressure measurement to determine that a static air system blockage has occurred. To do this, the pressure in the aircraft static air system is compared to the pressure in the aircraft cabin (nonpressurized aircraft cabins). When the static air system is operating correctly (not blocked), the difference between the pressure in the static air system and the pressure inside the nonpressurized aircraft cabin should be minimal (around 50 feet). If the static air system does become blocked, and the aircraft climbs or descends, the difference between the two pressures will become greater, increasing with the amount of altitude lost or gained in the descent or climb. The invention will detect these pressure differences and warn the user with an audible buzzer and light if the differential pressure passes a set trigger value.

Specifically, the device uses 1 Vacuum Switch and 1 Pressure Switch (FIGS. 1, 3, and 4) to detect a pressure difference between the static air system pressure and the aircraft cabin pressure. Two switches are needed for the following reason: if the aircraft is climbing after static air system blockage, there will be a higher pressure in the static line, and a lower pressure in the aircraft cabin; In this case the Pressure Switch will trigger the alarm. If the aircraft is descending after the static air system is blocked, there will be lower pressure in the static line and higher pressure in the aircraft cabin; In this case the Vacuum Switch will trigger the alarm.

Both the Pressure and the Vacuum Switch have tube ports which are attached to the static air system via a Tee Connecter (allowing the inputs to be fed from 1 tube). (FIGS. 1, 2).

The Pressure and the Vacuum Switch have their switch outputs wired to a latching relay (FIGS. 1, 6). The Latching Relay is needed due to the fact that the switches may only be momentarily on. If the static blockage is only for a small amount of time, even if one of the switches is on momentarily, the latching relay will latch in the on position and activate the light (FIGS. 1, 7) and buzzer (FIGS. 1, 8).

A reset switch (FIGS. 1, 9) is provided to allow the user to reset the light and buzzer after the unit has been activated.

A test switch (FIGS. 1, 10) is provided to allow the user to test the device.

The unit is set up to run on a 9 Volt Battery (FIGS. 1, 5). Because the unit does not use any power until one of the switches is activated, the battery is not drained by the unit over time.

Advantages

My invention allows a simple, reliable method to detect that the aircraft static air system has failed. It does not involve the use of computers, or computer calculations with external GPS or navigation units. It is a self contained system depending only on the differential pressures in the static air system vs. the aircraft cabin. Also, by using mechanical pressure and vacuum switches, it does not require any continuous electrical supply while in operation, it only uses the battery when the unit is warning of a problem, thus the battery will last a long time.

Also, because of the simple design, and the use of readily manufactured parts, the unit should be easily affordable for General Aviation pilots.

FIG. 2—Additional Embodiments

An additional embodiment would be the addition of an air valve to the invention. The air valve would be placed in series (with tubing) with the pressure and vacuum switches. When the unit warns of static air system blockage, the pilot could then operate the manual air valve, in effect allowing alternate static air (from the aircraft cabin) to enter into the static air system. This would allow use of the aircraft instruments. A note would need to be provided, that when using the cabin air pressure for the static air system, the instruments will not read with 100 percent accuracy; this is because the air pressure in the cabin of the aircraft will be slightly less than the air pressure in a static air system. This is due to the venturi effect of the air moving past the aircraft fuselage while in flight.

An additional embodiment would be the addition of an electric air valve that would automatically open the alternate static air source. The electric air valve would be operated off of the same relay used to power the warning light and warning buzzer.

Conclusions, Ramifications, and Scope

Accordingly, the reader will see that the Aircraft Static Air System Blockage Detector provides a cost-effective, reliable means of determining if blockage of the static system has occurred. It is simple to operate, in that it runs as a stand-alone unit, and does not require normal monitoring or adjustment by the user. It can provide a measure of safety when flying in conditions that could result in static air system blockage, as well as warn of blockage that had occurred on the ground while the aircraft had been parked.

Although the description above contains many specificities, these should not be construed as limiting the scope of the invention, but as merely providing illustrations of some of the presently preferred embodiments of this invention. For example, the invention could also compare the pressure altitude (from the static air system) output from the aircraft altitude encoder unit to the cabin air pressure (also adjusted to pressure altitude 29.92 in Hg). This would result in the same measurement of pressure differential between cabin and static pressure, the change being that the existing altitude encoder unit (used with all aircraft using an altitude reporting transponder) is used to provide the static air pressure reading. The invention could directly connect to the altitude encoder unit, or use a radio receiver tuned to the transponder frequency to determine the altitude encoder pressure altitude output. The transponder sends encoded messages to radar centers with the aircraft static air pressure altitude.

Thus, the scope of the invention should be determined by the appended claims and their legal equivalents, rather than by the examples given.

1. An aircraft static air system blockage detector, comprising:
(a) in combination, a connection to aircraft static air system, as well as connection to aircraft cabin air, and a means for detecting pressure differential between said aircraft static air system and said aircraft cabin air
(b) an indication that the said pressure differential has passed a preset limit
(c) whereby the aircraft operator can be warned of said static air system blockage
The aircraft static air system detector of claim 1 wherein said air valve is electrically or manually operated to connect the aircraft static air system to the aircraft cabin air
The aircraft static air system detector of claim 1 wherein said indication is provided by a piezoelectric buzzer and a light emitting diode
The aircraft static air system detector of claim 1 wherein said pressure differential is detected by one pressure switch and one vacuum switch
